(19) United States
(12) Patent Application Publication
(10) Pub. No.: US 2026/0088559 A1
(43) Pub. Date: Mar. 26, 2026

(54) LOCKING MECHANISMS FOR ELECTRICAL CONNECTORS

(71) Applicant: Enduralock, LLC, Lenexa, KS (US)

(72) Inventors: Harold Hess, Leawood, KS (US); Armando Perez, III, Los Angeles, CA (US); Deeptesh Selvaraj, Pitt Meadows (CA); Zoltan Szekely, Cypress, TX (US); Igor Komsitsky, Los Angeles, CA (US)

(21) Appl. No.: 18/896,238

(22) Filed: Sep. 25, 2024

(51) Int. Cl. H01R 13/622

(52) U.S. Cl. CPC H01R 13/622

(57) ABSTRACT

An electrical connection assembly includes a first electrical element, a second electrical element, and a lock assembly. The first electrical element and the second electrical element are engageable to provide an electrical connection. The lock assembly is positionable between a locked position in which the nut is fixed against rotation relative to the threaded member, and an unlocked position in which the nut is rotatable relative to the threaded member. The lock assembly includes a tooth that is configured to fix rotation of the nut relative to the threaded member in the locked position and that is displaced in the unlocked position. The first electrical element is engaged with the second electrical element when the lock assembly is in the locked position.

### BACKGROUND

The field of the disclosure relates generally to electrical connectors, and more specifically to locking mechanisms for electrical connectors.

Electrical connectors typically include components for joining two electrical elements (e.g., electrical conductors) and providing an electrical connection between the elements. For example, the electrical connectors may include a threaded bore and a threaded member that engage each other. The electrical connectors receive the electrical elements and facilitate the electrical elements making an electrical connection and securing the electrical elements together.

Electrical connectors are useful in many applications that require electrical connections between electrical elements. For example, aircraft can include thousands of electrical connectors that must be secured and remain secured for the aircraft to operate properly. However, conventional electrical connectors have not been completely satisfactory and may not be suitable for all applications. For example, electrical connectors may loosen over time when the electrical connectors are exposed to vibrations or stresses. In addition, electrical connectors can be difficult and time consuming to connect and/or repair. Moreover, at least some electrical connectors are expensive to manufacture.

Therefore, there is a need for mechanisms for electrical connectors that provide a secure connection, are quick and simple to secure, and are less expensive than other electrical connectors.

### BRIEF DESCRIPTION

In an aspect, an electrical connection assembly generally comprises a first electrical element, a threaded member coupled to the first electrical element, a second electrical element, a nut, and a lock assembly. The nut is coupled to the second electrical element and configured to threadingly engage the threaded member. The first electrical element and the second electrical element are engageable to provide an electrical connection when the nut is secured to the threaded member. The lock assembly is positionable between a locked position in which the nut is fixed against rotation relative to the threaded member, and an unlocked position in which the nut is rotatable relative to the threaded member. The lock assembly includes a tooth that is configured to fix rotation of the nut relative to the threaded member in the locked position and that is displaced in the unlocked position. The first electrical element is engaged with the second electrical element when the lock assembly is in the locked position.

In another aspect, an electrical connection assembly generally comprises a first electrical element, a second electrical element, and a lock assembly that is positionable between a locked position and an unlocked position. The lock assembly includes a lock member, a washer engageable with the lock member and fixed against rotation relative to one of the first electrical element or the second electrical element, and a tooth connected to the lock member or the washer. The tooth is configured to fix rotation of the lock member relative to the washer when the lock assembly is in the locked position, and allow rotation of the lock member relative to the washer when the lock assembly is in the unlocked position. The tooth is moved to switch the lock assembly between the locked position and the unlocked position. The first electrical element is engaged with the second electrical element when the lock assembly is in the locked position. The first electrical element and the second electrical element are fixed against rotation relative to each other by the lock member and the washer when the lock assembly is in the locked position.

In another aspect, an electrical connection assembly generally comprises a first electrical element, a second electrical element, a lock assembly, and a sleeve. The first electrical element and the second electrical element are engageable to provide an electrical connection. The first electrical element and the second electrical element extend along a longitudinal axis. The lock assembly is positionable between a locked position, and an unlocked position. The lock assembly includes a tooth that is configured to secure the lock assembly in the locked position. The sleeve is positionable around the lock assembly. The sleeve is rotated about the longitudinal axis to displace the tooth and cause the lock assembly to switch between the locked position and the unlocked position. The first electrical element is engaged with the second electrical element when the lock assembly is in the locked position.

In another aspect, a method of assembling an electrical connection assembly includes coupling a threaded member to a first electrical element, coupling a nut to a second electrical element, and coupling a lock assembly to at least one of the nut or the threaded member. The lock assembly is positionable between a locked position in which the nut is fixed against rotation relative to the threaded member, and an unlocked position in which the nut is rotatable relative to the threaded member. The lock assembly includes a tooth that is configured to fix rotation of the nut relative to the threaded member in the locked position and that is displaced in the unlocked position. The first electrical connection component is engaged with the second electrical connection component when the lock assembly is in the locked position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an example of an electrical connection assembly including a lock assembly and electrical connectors secured together;

FIG. 2 is a side view of the electrical connection assembly of FIG. 1, the lock assembly in a locked position;

FIG. 3 is a perspective view of the electrical connection assembly of FIG. 1 and a tool, the lock assembly in an unlocked position, the tool configured for tightening or loosening the electrical connection assembly if the lock assembly is in the unlocked position;

FIG. 4 is a cross-section view of the electrical connection assembly of FIG. 1, the lock assembly in the unlocked position;

FIG. 5 is a perspective view of the electrical connection assembly of FIG. 1, illustrating the electrical connectors detached from each other;

FIG. 6 is a perspective view of one of the electrical connectors;

FIG. 7 is a perspective view of another of the electrical connectors;

FIG. 8 is a cross-section view of the electrical connector of FIG. 7;

FIG. 9 is a perspective view of a portion of the electrical connection assembly of FIG. 1;

FIG. 10 is an exploded perspective view of a portion of the electrical connection assembly of FIGS. 1 and 9;

FIG. 11 is a perspective view of a nut of the electrical connection assembly of FIG. 10;

FIG. 12 is a perspective view of a retainer ring of the electrical connection assembly of FIG. 10;

FIG. 13 is a perspective view of the lock assembly of the electrical connection assembly of FIG. 1, the lock assembly including a washer and a lock member;

FIG. 14 is a perspective view of the washer of the lock assembly of FIG. 13, the washer including a notch;

FIG. 15 is a top view of the washer of FIGS. 13 and 14;

FIG. 16 is a perspective view of the lock member of FIG. 13, the lock member including a tooth configured to engage the notch of the washer of FIGS. 13 and 14;

FIG. 17 is a perspective view of another example of an electrical connection assembly, the electrical connection assembly including a sleeve to switch the lock assembly between the unlocked position and the locked position;

FIG. 18 is a cross-section view of the electrical connection assembly of FIG. 17;

FIG. 19 is a perspective view of the electrical connection assembly of FIG. 17, electrical connectors of the electrical connection assembly disconnected from each other;

FIG. 20 is a perspective view of a perspective view of a portion of the electrical connection assembly of FIG. 17;

FIG. 21 is another perspective view of a portion of the electrical connection assembly of FIG. 17;

FIG. 22 is a cross-section view of a portion of the electrical connection assembly of FIG. 17;

FIG. 23 is a perspective view of the sleeve coupled to a lock assembly of the electrical connection assembly of FIG. 17;

FIG. 24 is a perspective view of the sleeve of the electrical connection assembly of FIG. 17;

FIG. 25 is a first end view of the sleeve of the electrical connection assembly of FIG. 17;

FIG. 26 is second end view of the sleeve of the electrical connection assembly of FIG. 17;

FIG. 27 is a first end view of the electrical connection assembly of FIG. 17, illustrating the lock assembly in the locked position;

FIG. 28 is a second end view of the electrical connection assembly of FIG. 17, illustrating the lock assembly in the locked position;

FIG. 29 is a first end view of the electrical connection assembly of FIG. 17, illustrating the lock assembly in the unlocked position; and

FIG. 30 is a second end view of the electrical connection assembly of FIG. 17, illustrating the lock assembly in the unlocked position.

Unless otherwise indicated, the drawings provided herein are meant to illustrate features of embodiments of the disclosure. These features are believed to be applicable in a wide variety of systems. The drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Relative descriptors used herein such as upward, downward, left, right, up, down, length, height, width, thickness, and the like are with reference to the figures, and not meant in a limiting sense. Additionally, the illustrated embodiments can be understood as providing exemplary features of varying detail of certain embodiments, and therefore, features, components, modules, elements, and/or aspects of the illustrations can be otherwise combined, interconnected, sequenced, separated, interchanged, positioned, and/or rearranged without materially departing from the disclosed fastener assemblies. Additionally, the shapes and sizes of components are also exemplary and can be altered without materially affecting or limiting the disclosed technology.

The electrical connection devices and systems described herein are typically used to connect or join two electrical elements or to couple an electrical element to another assembly. The electrical connection devices and systems are used in a variety of applications such as, without limitation, aircraft applications, aerospace applications, automotive applications, industrial applications, building applications, fittings, and electrical connectors. Among other features and benefits, the disclosed electrical connection devices and systems described herein provide locking and vibration resistant electrical connections. For example, as described in the embodiments herein, when a tool is used with the associated electrical connection assembly, teeth or detent members on a lock assembly engage or disengage notches of another lock member (e.g., a nut and/or a lock washer). When the teeth are engaged with the notches, the nut is locked in rotation due to a rotational locking relationship of the lock assembly to a threaded member. When the teeth are disengaged from the notches, the nut is rotationally free relative to the threaded member. The advantages and other features of the technology disclosed herein will become more readily apparent to those having ordinary skill in the art from the following detailed description of the embodiments taken in conjunction with the drawings.

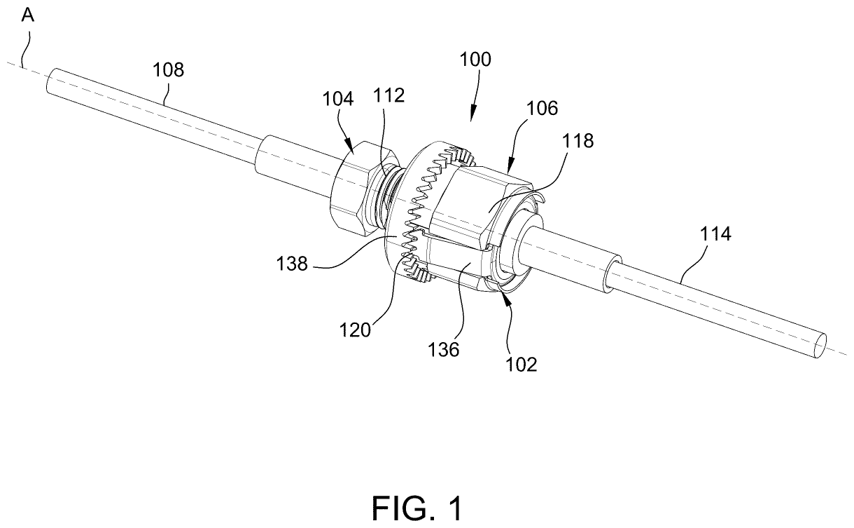

FIG. 1 is a perspective view of an example of an electrical connection assembly 100 including a lock assembly 102, a first electrical connector 104, and a second electrical connector 106. In the example, the electrical connectors 104, 106 define a longitudinal axis “A”. The electrical connectors 104, 106 are engaged with each other and secured together by the lock assembly 102.

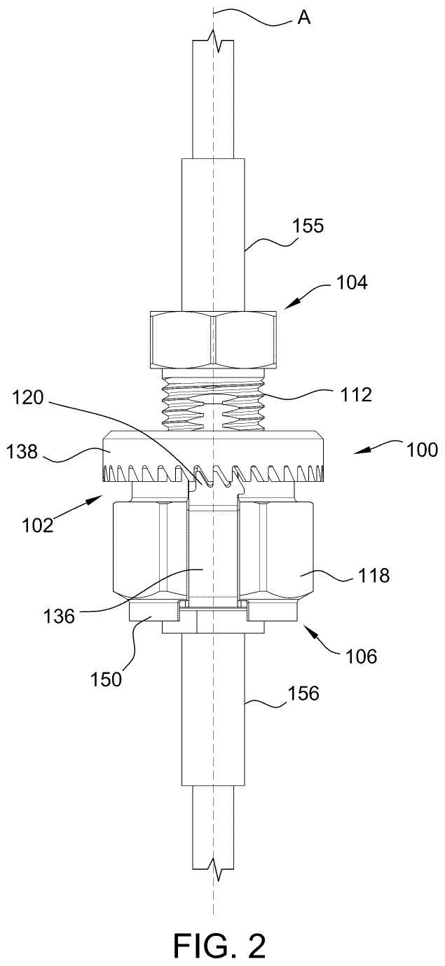

Referring to FIGS. 2-4, the electrical connection assembly 100 may include any suitable components. In the example illustrated in FIGS. 2-4, the first electrical connector 104 includes a first electrical element 108 and a threaded member 112 coupled to the first electrical element 108. The second electrical connector 106 includes a second electrical element 114 and a nut 118 coupled to the second electrical element 114. The electrical elements 108, 114 include, for example, cables comprising electrical conductors wrapped in an insulator.

In the example, an electrical contact 110 extends from an end of the first electrical element 108, and a pin 116 extends from an end of the second electrical element 114. The electrical contact 110 of the first electrical connector 104 and the pin 116 of the second electrical connector 106 are conductors and are configured to transfer electrical current received from one of the first electrical element 108 or the second electrical element 114 to the other of the first electrical element 108 or the second electrical element 114. In the example, the electrical connectors 104, 106 include one of electrical contact 110 and one pin 116. For example, the electrical connectors 104, 106 may be radio frequency (RF) connectors. In other embodiments, the electrical connectors 104, 106 may include more electrical contacts 110 and pins 116. For example, the electrical connectors 104, 106 may be configured as 6 pin connectors, 12 pin connectors, or any other suitable configuration.

The pin 116 is configured to engage the electrical contact 110 when the first electrical connector 104 is connected to the second electrical connector 106. For example, the first electrical contact 110 is coupled to the threaded member 112, and the pin 116 is coupled to the nut 118. The nut 118 of the second electrical connector 106 is configured to threadingly engage the threaded member 112 of the first electrical connector 104 such that the electrical contact 110 contacts the pin 116. Accordingly, the first electrical connector 104 and the second electrical connector 106 provide an electrical connection between the first electrical element 108 and the second electrical element 114 when the first electrical connector 104 is secured to the second electrical connector 106.

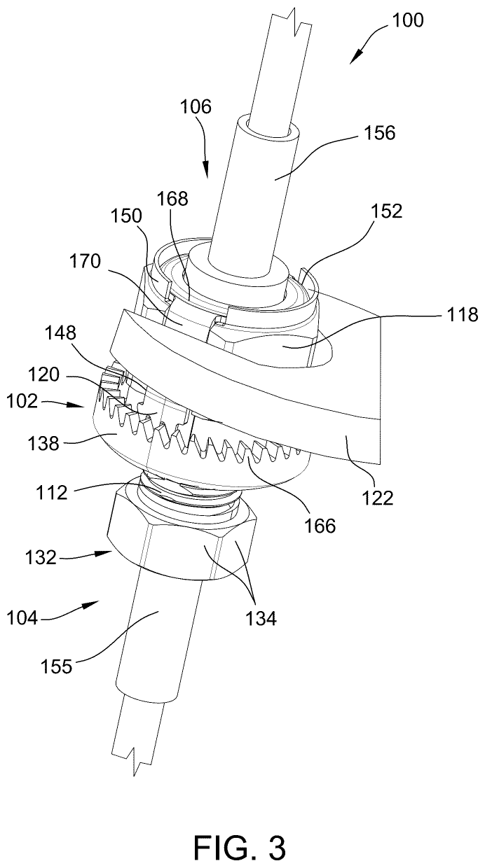

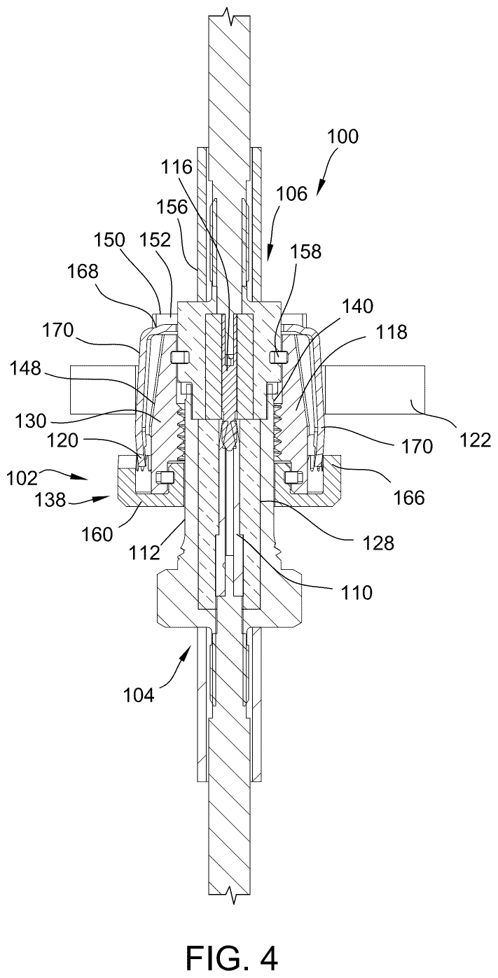

The lock assembly 102 is releasably coupled to the nut 118 and the threaded member 112 to facilitate securing the nut 118 to the threaded member 112. The lock assembly 102 is positionable between a locked position (shown in FIGS. 1 and 2) in which the nut 118 of the second electrical connector 106 is fixed against rotation relative to the threaded member 112 of the first electrical connector 104, and an unlocked position (shown in FIGS. 3 and 4) in which the nut 118 is rotatable relative to the threaded member 112. For example, the lock assembly 102 includes at least one tooth 120 that is configured to fix rotation of the nut 118 relative to the threaded member in the locked position and that is displaced in the unlocked position.

In the example, when the lock assembly 102 is in the locked position, the electrical connectors 104, 106 are secured together such that the electrical elements 108, 114 are in electrical communication with each other and the electrical connection assembly 100 facilitates transfer of electrical signals therebetween. For example, the electrical contact 110 is engaged with the pin 116 when the lock assembly 102 is in the locked position.

The lock position of the lock assembly 102 facilitates a secure connection between the electrical elements 108, 114 and resists loosening of the electrical connection assembly 100. For example, in the locked position, the lock assembly 102 prevents rotation of the nut 118 relative to the threaded member 112 even when the electrical connection assembly 100 experiences vibrations or harsh conditions. Moreover, the lock assembly 102 provides quick and simple locking of the electrical connection assembly 100. In the example, the lock assembly 102 moves to the lock position when the nut 118 is tightened on the threaded member 112 to a desired position and the tool is removed from the lock assembly 102 (if a tool is used).

Referring to FIGS. 3-5, the lock assembly 102 is switched from the locked position to the unlocked position by, for example, positioning a tool 122 such as a conventional socket or wrench around the nut 118 and the lock assembly 102. For example, the tool 122 causes the teeth 120 on the finger 170 to be displaced and the lock assembly 102 to switch from the locked position to the unlocked position when the tool 122 engages the electrical connection assembly 100. The tool 122 is configured for tightening or loosening the electrical connection assembly 100 if the lock assembly 102 is in the unlocked position. Accordingly, the lock assembly 102 does not require a specialized tool to switch between the locked position and the unlocked position. Also, in some embodiments, the lock assembly 102 may be switched between the locked position and the unlocked position without the use of the tool 122. For example, a user may contact the lock assembly 102 and manually displace the teeth 120.

In the unlocked position of the lock assembly 102, the nut 118 is rotatable relative to the threaded member 112. For example, when the lock assembly 102 is in the unlocked position, the nut 118 may be rotated to loosen and disengage the nut 118 from the threaded member 112 and, thereby, disconnect the first electrical connector 104 from the second electrical connector 106. The first electrical connector 104 and/or the second electrical connector 106 may then be connected to another electrical connector (not shown). Suitably, the first electrical connector 104 and the second electrical connector 106 are configured to connect to standard connectors. Moreover, the lock assembly 102 is configured to secure together the first electrical connector 104, the second electrical connector 106, and/or other connectors. Accordingly, the lock assembly 102 facilitates securing a broad range of electrical connectors.

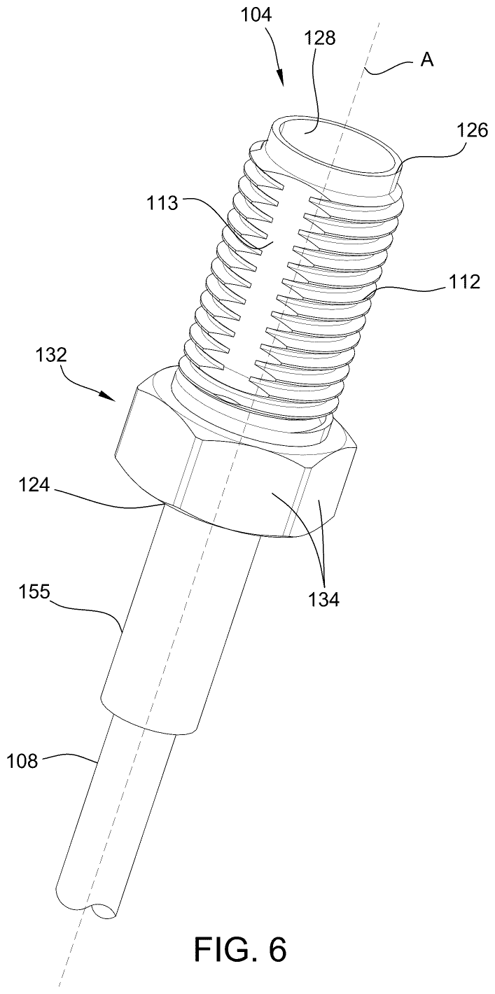

FIG. 6 is a perspective view of the first electrical connector 104. In this example, the first electrical connector 104 has a first end 124 and a second end 126 and includes the threaded member 112 and a body 132. The threaded member 112 and the body 132 extend along the longitudinal axis A from the first end 124 to the second end 126. In the example, the threaded member 112 and the body 132 are hollow and define a central bore 128 extending from the first end 124 to the second end 126.

The body 132 has tool engagement surfaces 134. The tool engagement surfaces 134 are configured in a hexagonal-shaped arrangement, although other configurations are contemplated. The tool engagement surfaces 134 correspond to one or more tools 122 (shown in FIGS. 3 and 4), for example, and without limitation, a wrench and/or a socket. As such, the tool engagement surfaces facilitate tightening and/or loosening the electrical connection assembly 100 using common hand tools, and without requiring use of a specialized tool.

The threaded member 112 extends from the body 132 to the second end 126 of the first electrical connector 104. The threaded member 112 is a cylinder with threads extending around a circumference of the threaded member 112. The threaded member 112 is configured to threadingly engage the nut 118 (shown in FIG. 1). In addition, the threaded member 112 is sized to receive at least a portion of the lock assembly 102 (shown in FIG. 1). In the example, the threaded member 112 includes anti-rotation surfaces (e.g., planar surfaces) 113 that are configured to engage the lock assembly 102 (shown in FIG. 1).

As seen in FIG. 6, the first electrical connector 104 includes a ferrule 155 that extends from the body 132. The ferrule 155 is hollow and is shaped to receive the first electrical element 108 within a hollow inner cavity of the ferrule 155. In some embodiments, the ferrule 155 is omitted and the first electrical element 108 is secured to the threaded member 112 via fasteners, adhesives, clamps, and/or any suitable attachment means.

Referring to FIGS. 4 and 6, at least a portion of the first electrical element 108 extends into the central bore 128 of the first electrical connector 104. For example, the electrical contact 110 extends within the central bore 128 and is configured to engage the pin 116 of the second electrical element 114 within the central bore 128. In some embodiments, the electrical contact 110 extends outside of the central bore 128. The electrical contact 110 and the pin 116 are configured to form an electrical connection and transfer electrical signals when the electrical contact 110 engages the pin 116 within the central bore of the first electrical connector 104.

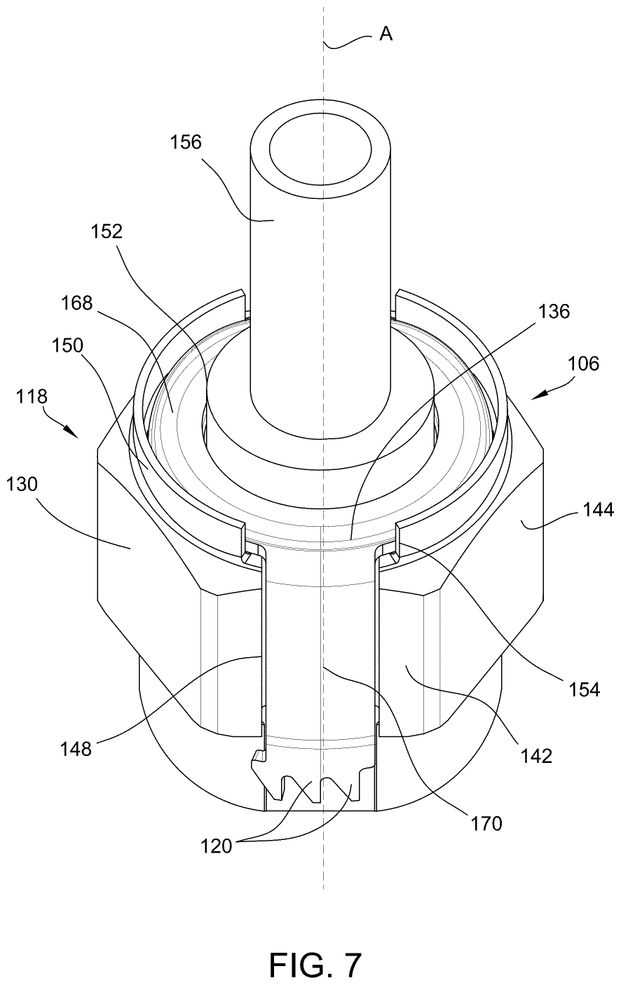

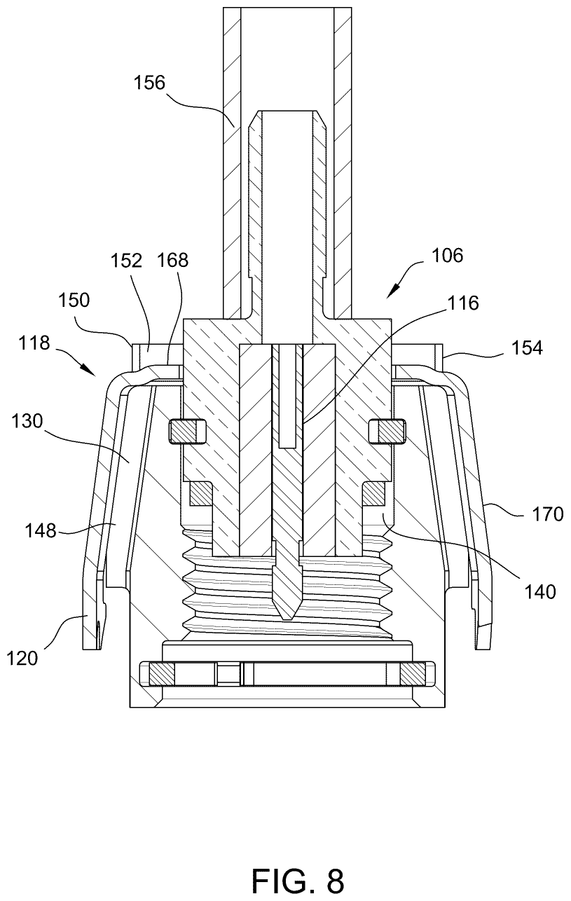

FIG. 7 is a perspective view of the second electrical connector 106. FIG. 8 is a cross-section view of the second electrical connector 106. The second electrical connector 106 includes the second electrical element 114 and the nut 118. The second electrical connector 106 extends along the longitudinal axis A.

Also, the second electrical connector 106 includes a ferrule 156 that extends from the nut 118. The ferrule 156 is hollow and is shaped to receive at least a portion of the second electrical element 114 within the hollow inner cavity of the ferrule 156. The pin 116 is engaged with a conductor of the second electrical element 114 (shown in FIG. 1) in the ferrule 156. In some embodiments, the ferrule 156 is omitted and the second electrical element 114 is secured to the nut 118 via fasteners, adhesives, clamps, and/or any suitable attachment means.

The pin 116 is positioned partly within the nut 118 and partly within the ferrule 156, as seen in FIG. 8. The pin 116 is configured to engage with the electrical contact 110 (shown in FIG. 4) when the first electrical connector 104 (shown in FIG. 1) is received within the nut 118 of the second electrical connector 106.

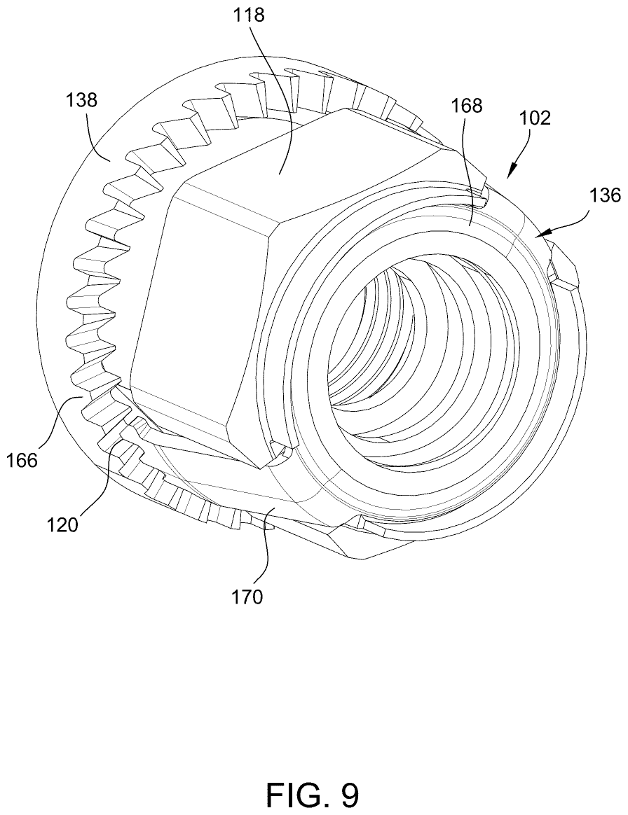

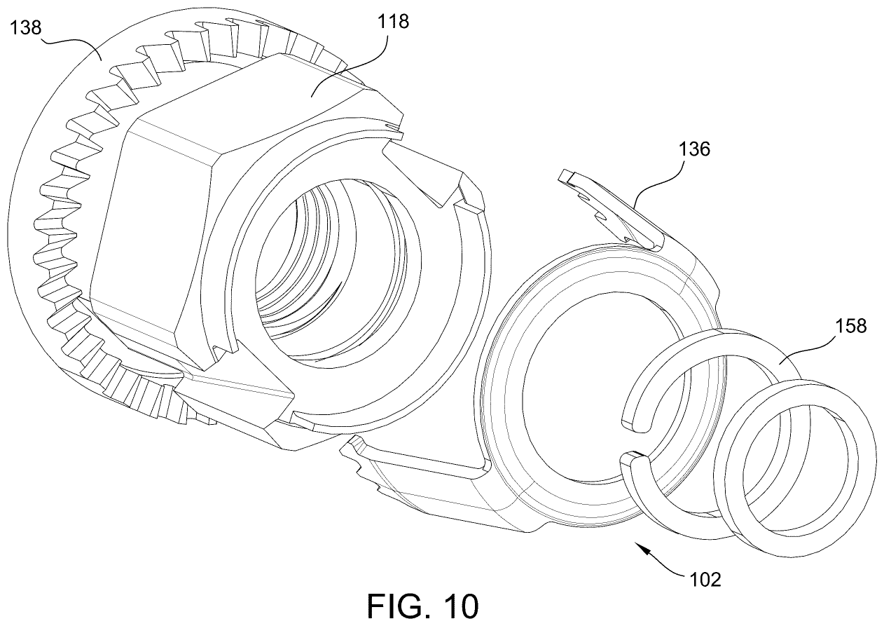

As seen in FIGS. 9-11, the lock assembly 102 includes a lock member 136 and a washer 138. The lock member 136 includes an annular body 168 and at least one spring finger 170. The lock assembly 102 is releasably coupled to the nut 118 and/or the threaded member 112. For example, the lock member 136 is releasably coupled to the nut 118 and the washer 138 is releasably coupled to the threaded member 112.

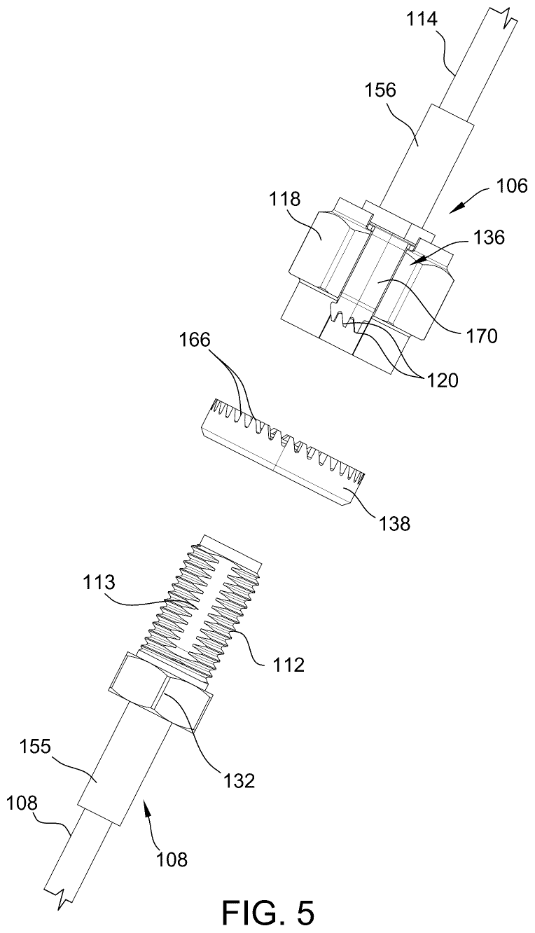

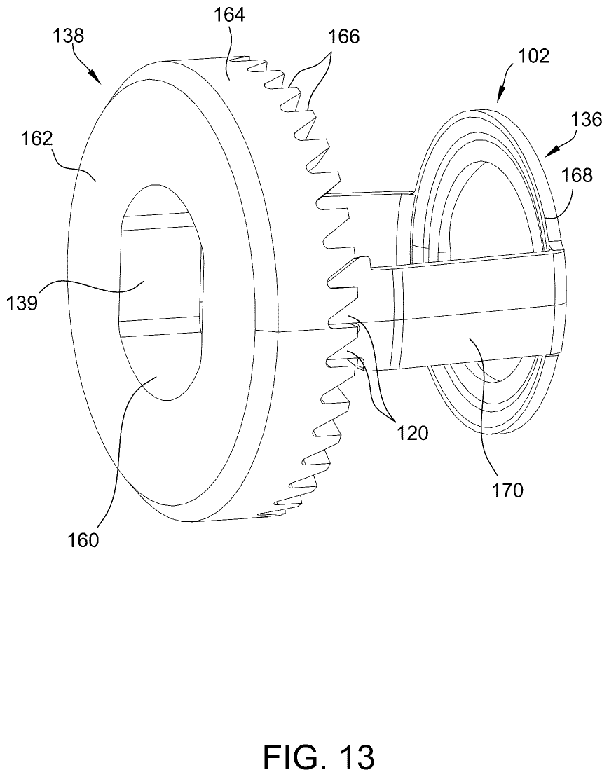

Referring to FIGS. 5 and 9-11, the washer 138 is releasably coupled to and engaged with the threaded member 112. For example, the washer 138 is sized and shaped to be positioned onto the threaded member 112 and engage the threaded member 112 such that the washer 138 is fixed against rotation relative to the threaded member 112 when the washer 138 is coupled to the threaded member 112. In particular, the washer 138 includes planar engagement surfaces 139 (shown in FIG. 13) that engage the anti-rotation surfaces 113 of the threaded member 112.

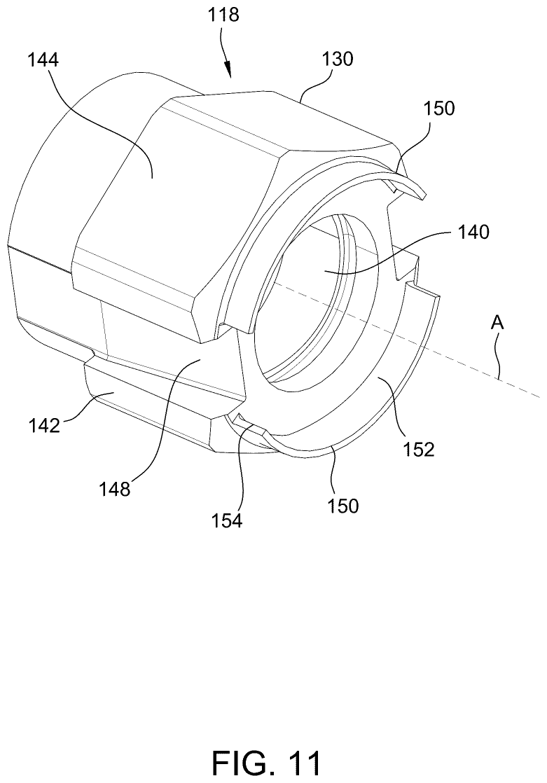

FIG. 11 is a perspective view of the nut 118 of the second electrical connector 106. The nut 118 includes a threaded body 130 that extends along the longitudinal axis A and a collar 150 extending axially from an end of the threaded body 130. The collar 150 includes curved sections that extend around partly along a circumference of the nut 118. The collar 150 defines a recess 152 and notches 154.

Also, the nut 118 has one or more slotted circumferential faces 142 and one or more continuous faces 144. The slotted circumferential faces 142 define axially-extending slots 148. In the example, each slotted circumferential face 142 defines one of the axial slots 148. In the example, two of the axial slots 148 extend generally axially along respective slotted circumferential faces between the top and bottom surfaces of the nut 118, and each have a circumferential width sized to receive a spring finger 170 of the lock member 136. In the example, the threaded member 112 includes the two axial slots 148 disposed on diametrically-opposed slotted circumferential faces, i.e. on slotted circumferential faces that are substantially parallel to each other and generally symmetrical with respect to longitudinal axis “A.”

Referring to FIGS. 4 and 11, the body 130 of the nut 118 defines an inner cavity 140 sized and shaped to receive the male threaded portions of the threaded member 112 therein. The nut 118 includes threads on an interior of the body 130 that are configured to threadingly engage male threaded portions of the threaded member 112.

The slotted circumferential faces 142 and continuous faces 144, collectively, define tool engagement surfaces that extend along the longitudinal axis A of the electrical connection assembly 100. The tool engagement surfaces are configured in a hexagonal-shaped arrangement, although other configurations are contemplated. As seen in FIGS. 3 and 4, the tool engagement surfaces correspond to one or more tools 122, for example, and without limitation, a wrench and/or a socket. As such, the tool engagement surfaces facilitate tightening and/or loosening the electrical connection assembly 100 using common hand tools, and without requiring use of a specialized tool.

In the example, the nut 118 has a collar 150 that extends axially from an end of the nut 118 and defines the recess 152 to receive the annular body 168 of the lock member 136. The collar 150 defines the notches 154 that align with the slots 148 in the slotted circumferential faces 142. Accordingly, the spring fingers 170 extend through the notches 154 and into the slots 148 when the annular body 168 of the lock member 136 is positioned in the recess 152.

As seen in FIG. 9, the lock member 136 is positioned within the recess 152 defined by the collar 150 of the nut 118 and is rotatable with the nut 118. Specifically, the annular body 168 of the lock member 136 is positioned within the recess 152 such that the spring fingers extend through the 154 and are aligned with the slots 148. The slots 148 of the nut 118 facilitate fixing lock member 136 and the nut 118 rotationally with respect to each other when the spring fingers 170 are aligned with and positioned within the axial slots 148. In particular, the spring fingers 170 snap into the axial slots 148 to facilitate coupling lock member 136 to the nut 118. In alternative embodiments, the nut 118 includes a fewer or greater number of the axial slots 148.

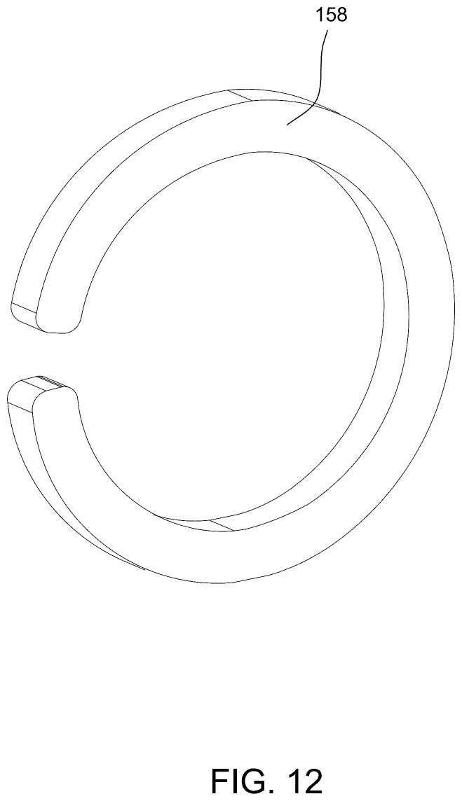

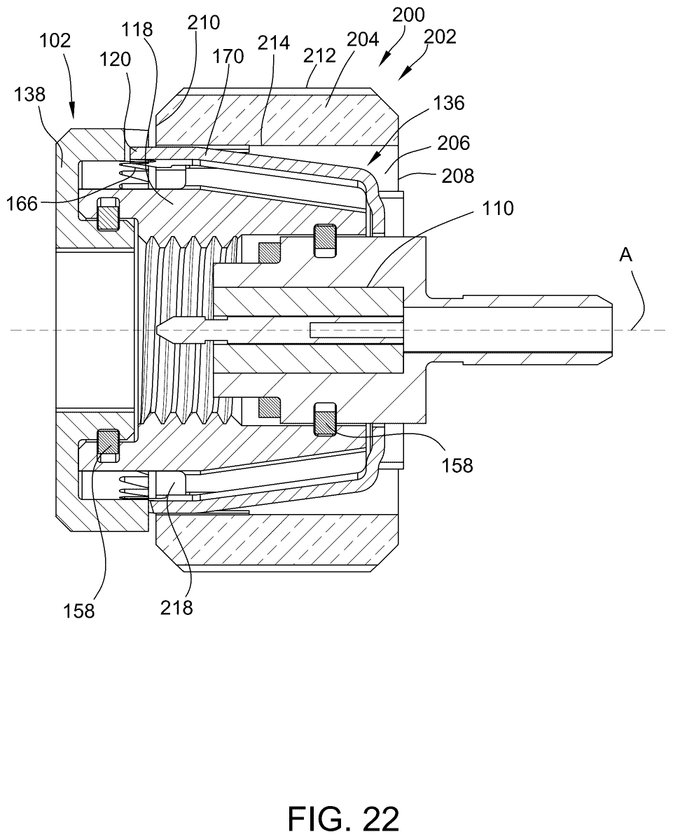

FIG. 12 is a perspective view of a retainer ring 158 of the electrical connection assembly 100. Referring to FIGS. 4 and 12, the retainer ring 158 is an annular ring that is sized to extend into grooves in the nut 118 and the pin 116 of the second electrical connector 106 and secure the pin 116 to the nut 118. In other embodiments, the retainer ring 158 may be omitted and the nut 118 may be connected to the pin 116 by pins, fasteners, adhesives, or any other suitable means. In some embodiments, the retainer ring 158 (or another retainer ring) is positioned in a groove on the washer 138 (shown in FIG. 1) and the nut 118 to secure the washer 138 in position relative to the lock member 136, as seen in FIG. 22.

FIG. 13 is a perspective view of the lock assembly 102 of the electrical connection assembly 100. The lock assembly 102 includes the washer 138 and the lock member 136. The lock assembly 102 is positionable between the locked position (shown in FIGS. 3 and 4) and the unlocked position (shown in FIGS. 5 and 6). The lock member 136 is fixed against rotation relative to the washer 138 when the lock assembly 102 is in the locked position, and the lock member 136 is rotatable relative to the washer 138 when the lock assembly 102 is in the unlocked position.

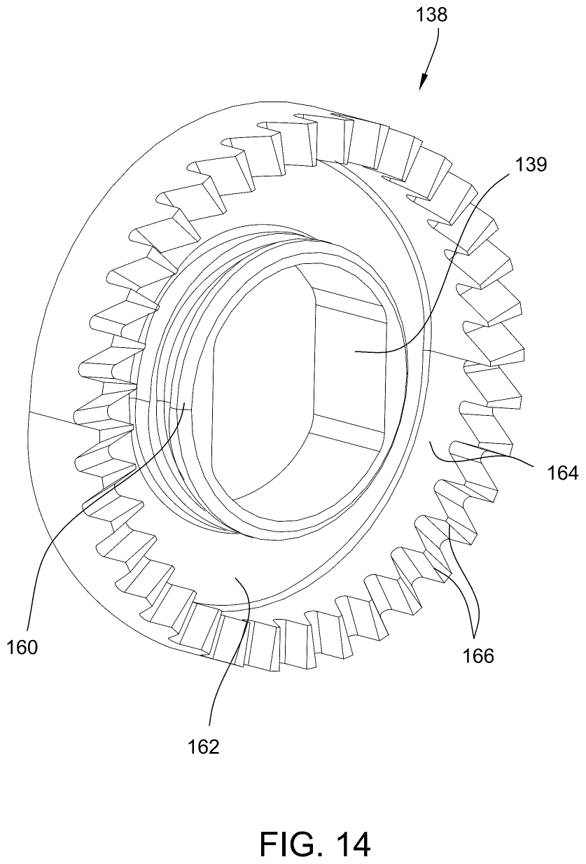

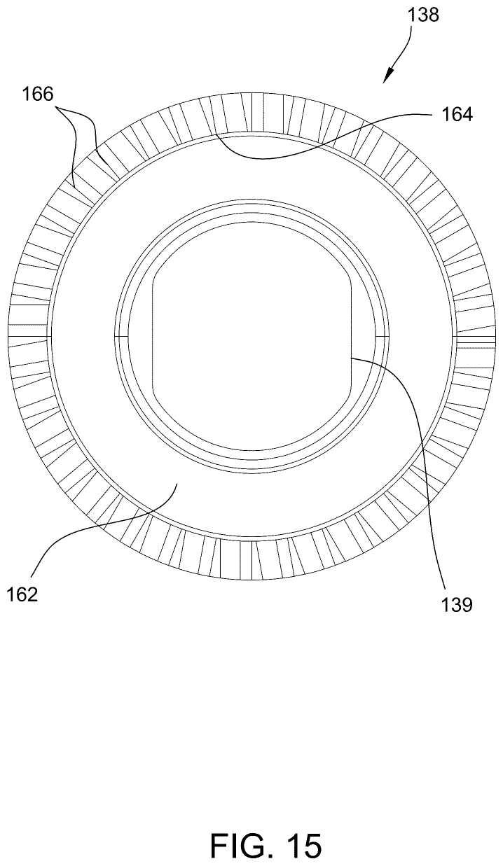

FIG. 14 is a perspective view of the washer 138 of the lock assembly 102. FIG. 15 is a top view of the washer 138. The washer 138 includes a body 160 and a flange 162 extending radially outward from an end of the body 160. A circumferential axially-extending wall 164 extends about a periphery of the flange 162. The circumferential wall 164 comprises notches or teeth 166 formed on an end of the circumferential wall 164. In the example, the nut 118 includes notches 166 that are equally spaced around the entire circumference of the circumferential wall 164. The notches 166 extend axially and are arranged to engage teeth 120 of the lock member 136, as shown in FIG. 13. In other embodiments, the notches 166 may extend radially from the circumferential wall 164 and/or the flange 162.

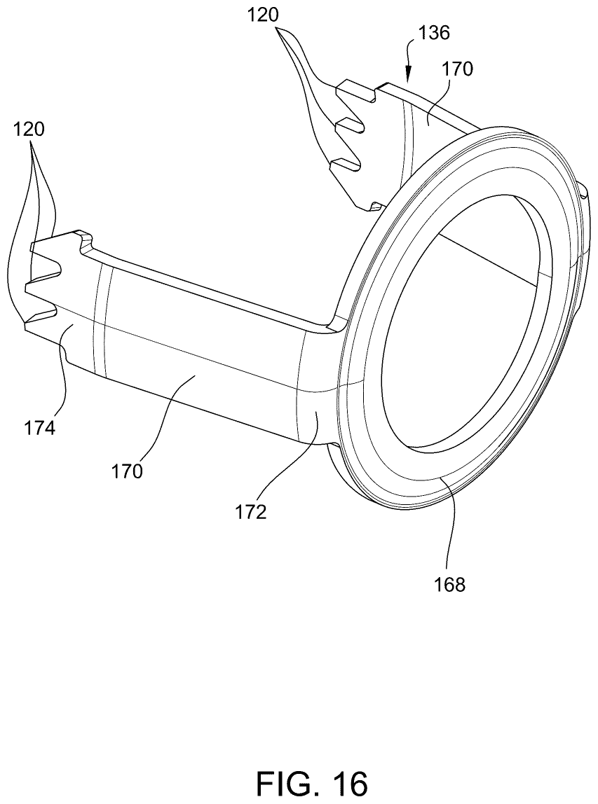

FIG. 16 is a perspective view of the lock member 136 of the lock assembly 102. The lock member 136 includes an annular body 168 and at least one axially-extending spring finger 170 coupled to the annular body 168. Each axially-extending spring finger 170 extends at least partly along a longitudinal axis A of the lock assembly 102. In the example, the lock member 136 includes a pair of the axially-extending spring fingers 170 on opposite sides of the annular body 168. Each axially-extending spring finger 170 includes a fixed end 172 coupled to the annular body 168 and a free end 174 opposite the fixed end 172. The free end 174 is movable in a direction not parallel to the longitudinal axis A (e.g., a radial direction) when the lock assembly 102 is switched between the locked position and the unlocked position. The lock assembly 102 includes teeth 120 that extend axially from the free end 174. In the example, the teeth 120 are integrally formed as a single piece with the axially-extending spring finger 170 and the annular body 168.

Referring to FIGS. 9 and 16, in the example, the annular body 168 of the lock member 136 is a generally circular ring having a predetermined wall thickness, that when combined with an internal diameter, facilitates fitting the annular body 168 within the recess 152 of the nut 118 and facilitates coupling the lock member 136 to the nut 118. In other embodiments, the annular body 168 may have shapes other than circular, for example, and without limitation, the annular body 168 may be round, oval, ellipsoid, or any other suitable shape.

In the example, the annular body 168 and the spring fingers 170 of the lock member 136 are fabricated from a resilient metallic material, such as a spring steel. Accordingly, the lock member 136 provides a bias force to bias the lock assembly 102 toward the locked position. Alternatively, the lock member 136 is fabricated from any resilient material that enables lock member 136 to function as described herein, for example, and without limitation, resilient composite materials, resins, fiber reinforced resins, plastics, and fiber reinforced plastics.

In the example, each spring finger 170 extends axially from the annular body 168. In addition, the spring finger 170 is angled from the fixed end 172 to the free end 174 such that the spring finger 170 extends radially outward from the annular body 168. The fixed end 172 is coupled to annular body 168. The free end 174 includes the teeth 120. While the lock member 136 is described with two spring fingers 170, in alternative embodiments, the lock member 136 includes fewer or greater than two spring fingers 170, such that, for example, a respective spring finger 170 is circumferentially-positioned relative to a respective axial slot 148 of the nut 118.

As described above, one or more axially-extending teeth 120 (or detent members) are disposed on the free end 174 of each spring finger 170. In particular, in the example, sets of three adjacent axially-extending teeth 120 are disposed on the free ends 174 of the respective spring fingers 170. Each tooth 120 includes a sliding surface and a securing surface. The sliding surface and the securing surface of the tooth are sized and shaped to correspond to a sliding surface and a securing surface, respectively, of notches 166 of the washer 138 and provide a ratcheting action.

In the example, the teeth 120 are configured to facilitate preventing rotation that affects loosening of the nut 118 with respect to the threaded member 112 (shown in FIG. 1), for example, in a counter-clockwise direction. Alternatively, the teeth 120 are configured to facilitate preventing rotation of the nut 118 in the clockwise direction, or both the counter-clockwise and the clockwise directions. While the lock member 136 is shown with three teeth 120 on each spring finger 170, in alternative embodiments, the lock member 136 includes fewer or greater than three teeth 120.

Referring to FIGS. 9-13, the washer 138 is engageable with the lock member 136 when the lock assembly 102 is in the locked position. For example, the notches 166 of the washer 138 receive and engage the teeth 120 of the lock member 136 when the lock assembly 102 is in the locked position. The teeth 120 and the notches may be configured for ratcheting engagement such that the notches 166 and the teeth 120 allow rotation of the lock assembly 102 in one direction (e.g., clockwise or counter-clockwise) for tightening the lock assembly 102 and prevent rotation in an opposite direction when the notches 166 and the teeth 120 are engaged.

As shown in FIGS. 1 and 9, in the locked position, the spring fingers 170 of the lock member 136 sit within the axial slots 148 of the nut 118. As such, the lock member 136 and the nut 118 are caused to rotate together. The teeth 120 of the lock assembly 102 are positioned to engage the notches 166 on the washer 138. Consequently, when one or more axially-extending teeth 120 of lock member 136 seats against the notches 166 of the washer 138, the lock member 136 becomes rotationally-fixed relative to the washer 138, causing the nut 118 to become rotationally-fixed relative to the washer 138 coupled to the threaded member 112.

In addition, as shown in FIGS. 1, 2, and 13, in the locked position, the engagement surfaces of the washer 138 engage the threaded member 112 and prevent rotation of the lock assembly 102 relative to the threaded member 112. As a result, the lock assembly 102 is fixed against rotation and the electrical connection assembly 100 is prevented against loosening when the nut 118 is tightened onto the threaded member 112 and the lock assembly 102 is in the locked position. For example, when one or more axially-extending teeth 120 of lock member 136 seats against the notches 166 of the washer 138, the lock member 136 becomes rotationally-fixed relative to the washer 138 and the nut 118, causing the nut 118 to become rotationally-fixed relative to the lock member 136 and the threaded member 112.

In the example, the lock assembly 102 is switched between the locked position and the unlocked position by displacing the teeth 120 of the lock assembly 102. For example, the teeth 120 of the lock member 136 are displaced radially inward and disengaged from the notches 166 of the washer 138 to switch the lock assembly 102 from the locked position to the unlocked position. In other embodiments, the teeth 120 and/or the notches 166 are moved in any direction (e.g., radially and/or axially) to switch the lock assembly 102 between the locked position and the unlocked position.

As described above, the spring fingers 170 of the lock member 136 are biased to facilitate maintaining locking engagement of axially-extending teeth 120 and notches 166 of the washer 138. In the unlocked position, each spring finger 170 is displaced radially inward to disengage the teeth 120 from the notches 166. Accordingly, in the unlocked position, the nut 118 and the lock member 136 are able to rotate relative to the washer 138 and the threaded member 112.

With reference to FIGS. 3 and 4, to facilitate displacing the spring fingers 170 radially inward, as described herein, the tool 122, such as a conventional socket or wrench, is coupled to the nut 118. The tool 122 contacts the spring fingers 170 and displaces the spring fingers 170 radially inward. As result, the teeth 120 on the lock member 136 disengage from the notches 166 on the washer 138. The tool 122 may be used to rotate the nut 118 either clockwise or counterclockwise about longitudinal axis “A,” tightening the nut 118 or loosening the nut 118 as appropriate. In some embodiments, the tool 122 may be used to rotate the threaded member 112 relative to the nut 118.

In the example, components of the electrical connection assembly 100 such as the nut 118, the threaded member 112, the lock member 136, and the washer 138 are fabricated from a metal, for example, and without limitation, steel, aluminum, titanium, or a superalloy. Alternatively, the nut 118, the threaded member 112, the lock member 136, and/or the washer 138 is fabricated from any material that enables the electrical connection assembly 100 to function as described herein, such as, for example, and without limitation, composite materials, resins, fiber reinforced resins, plastics, and fiber reinforced plastics.

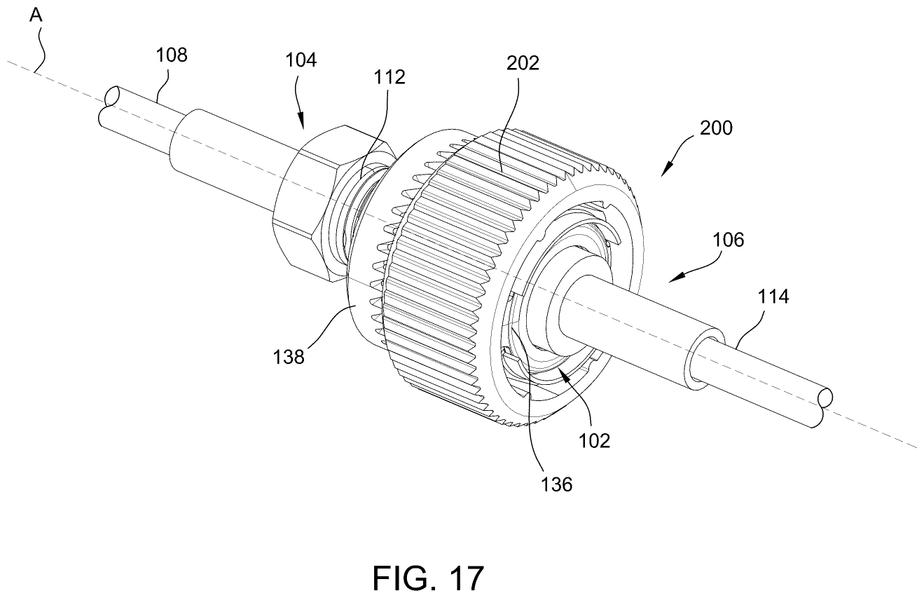

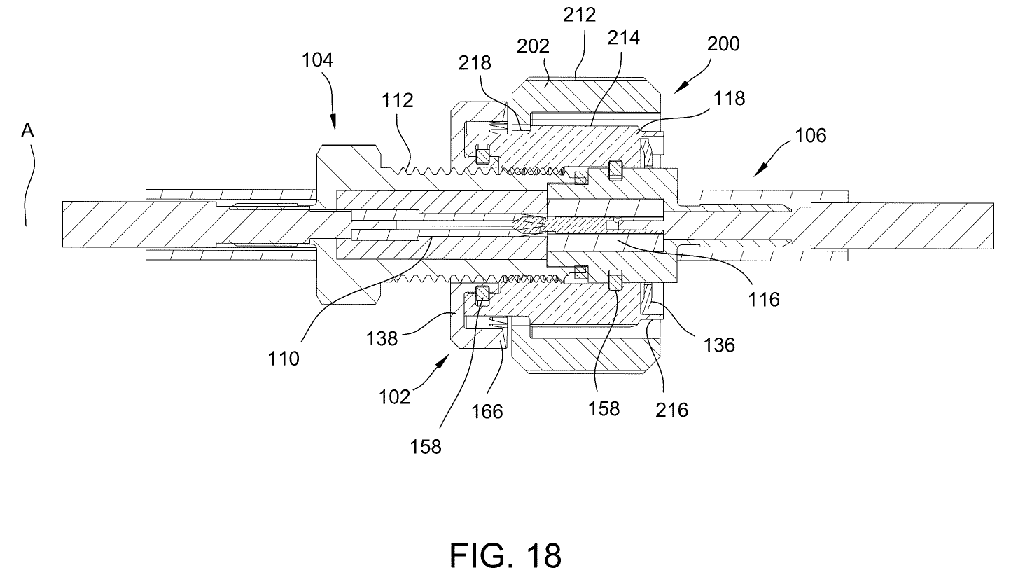

FIG. 17 is a perspective view of another example of an electrical connection assembly 200. FIG. 18 is a cross-section view of the electrical connection assembly 200. The electrical connection assembly 200 is similar to the electrical connection assembly 100 shown in FIG. 1, except the electrical connection assembly 200 includes a sleeve 202 arranged to switch the lock assembly 102 between the unlocked position and the locked position.

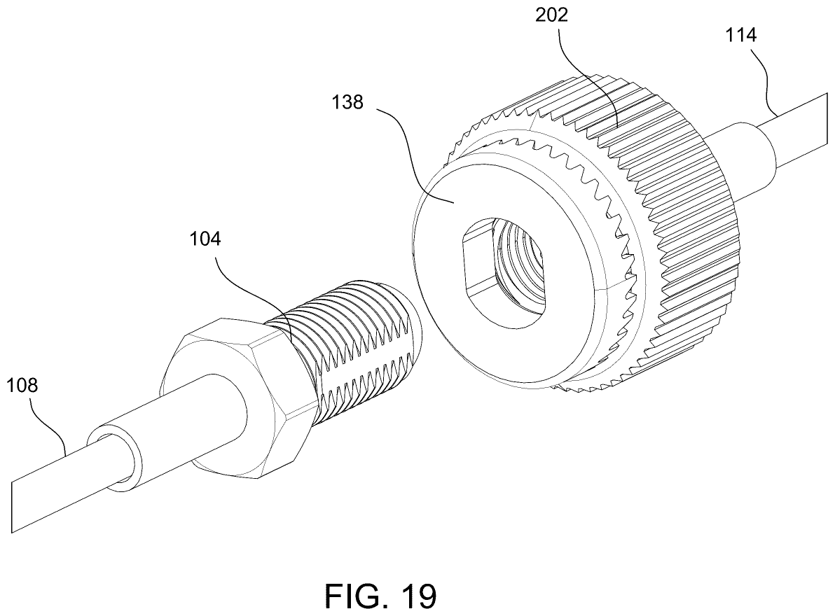

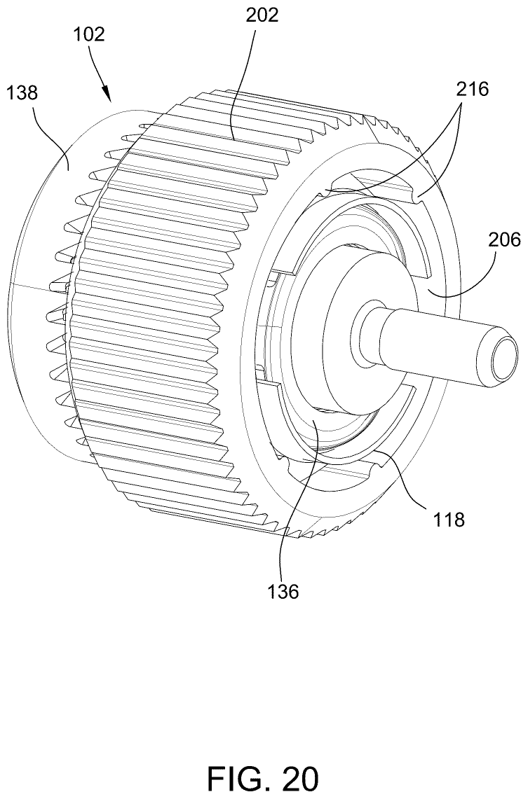

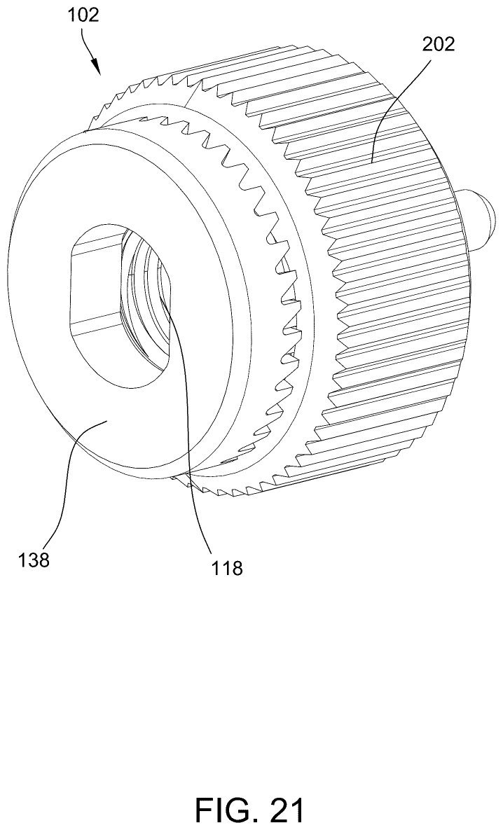

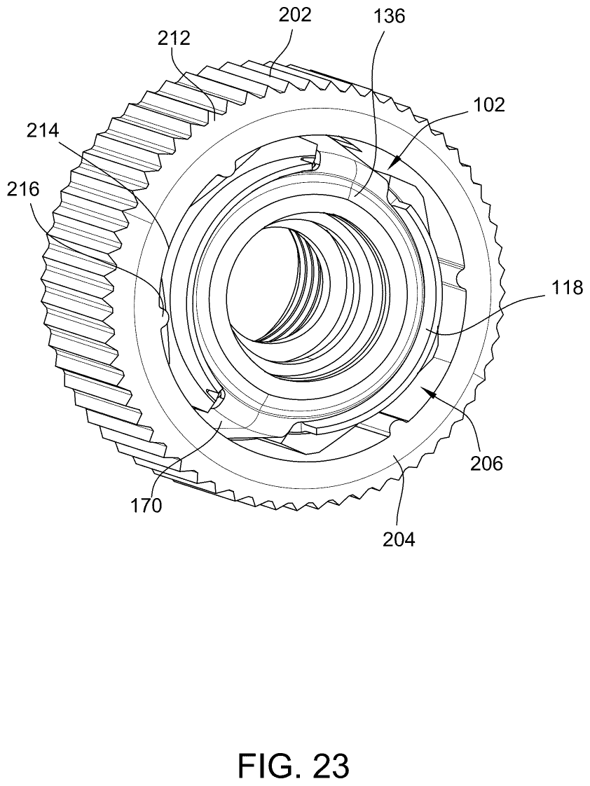

Referring to FIGS. 19-23, the sleeve 202 extends circumferentially around the nut 118 and around the lock member 136 coupled to the nut 118. The sleeve 202 is arranged to selectively engage the axially-extending spring fingers 170 and cause displacement of the axially-extending spring fingers 170. For example, the sleeve 202 is movably coupled to the nut 118. The sleeve 202 is displaced (e.g., moved axially and/or rotated) to switch the lock assembly 102 between the locked position and the unlocked position. In the example illustrated in FIGS. 19-23, the sleeve 202 is rotated relative to the nut 118 about the longitudinal axis A to switch the lock assembly 102 between the locked position and the unlocked position.

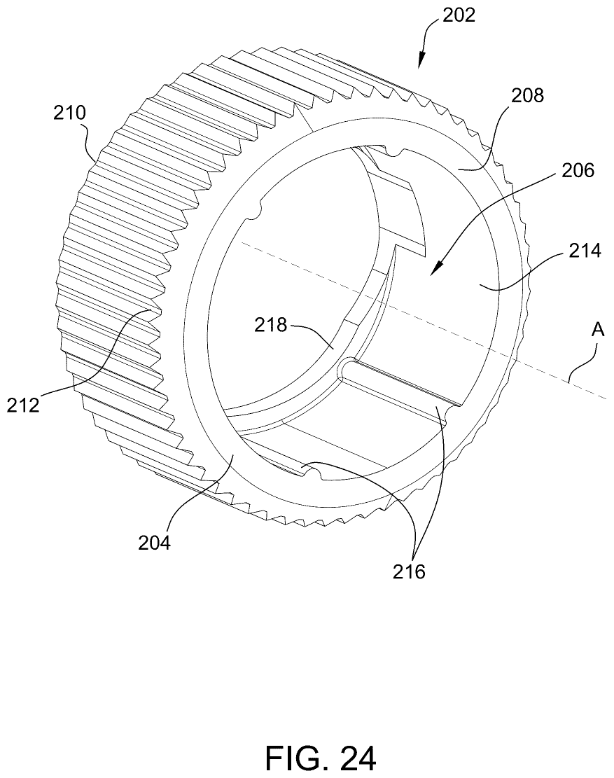

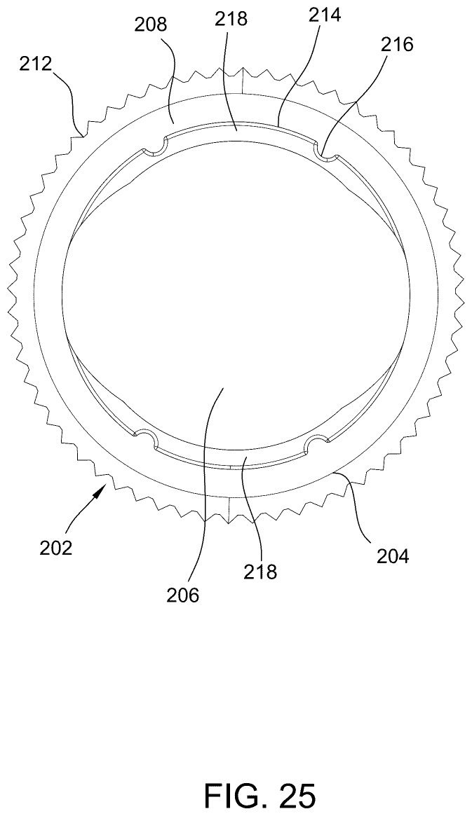

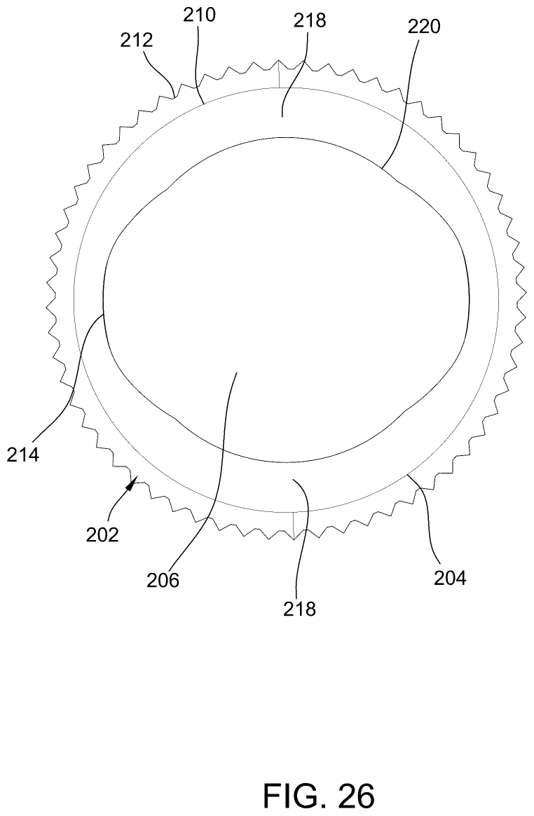

FIG. 24 is a perspective view of the sleeve 202 of the electrical connection assembly 200. FIG. 25 is a first end view of the sleeve 202. FIG. 26 is second end view of the sleeve 202. The sleeve 202 includes a body 204 defining a bore 206 and extending from a first end 208 to a second end 210. The body 204 is shaped as a hollow cylinder and extends around the longitudinal axis A. In the example, an outer circumferential surface 212 of the body 204 includes grips (e.g., ridges) to facilitate gripping and rotating the sleeve 202. In other embodiments, the body 204 does not include any surface features or includes other surface features. For example, in some embodiments, the outer circumferential surface 212 of the sleeve 202 is smooth.

The sleeve 202 includes ribs 216 projecting radially inward from an inner circumferential surface 214 of the sleeve 202. The ribs 216 extend from the first end 208 to the second end 210 of the body 204 in a direction parallel to the longitudinal axis A. In the example, the sleeve 202 includes four of the ribs 216 evenly spaced around the inner circumferential surface 214 of the sleeve 202. In other suitable embodiments, the sleeve 202 may include any number of ribs 216 (e.g., one, two, three, five, or more of the ribs 216). In some embodiments, the ribs 216 are omitted.

Also, the sleeve 202 includes flanges 218 that extend radially inward from the inner circumferential surface 214 at the second end 210 of the body 204. The flanges 218 have a curved edge 220 providing a tapered shape of the flanges 218 (e.g., the flanges 218 have a maximum width and taper down to a minimum width). The flanges 218 do not extend around the entire circumference of the body 204. In the example, the flanges 218 are on diametrically opposite sides of the body 204 of the sleeve 202. Accordingly, the flanges 218 define a reduced width of the opening at the second end 210 of the body 204. Specifically, the width of the opening at the second end 210 between the flanges 218 is less than a width of the opening between sections of the inner circumferential surface 214 where the flanges 218 are not located.

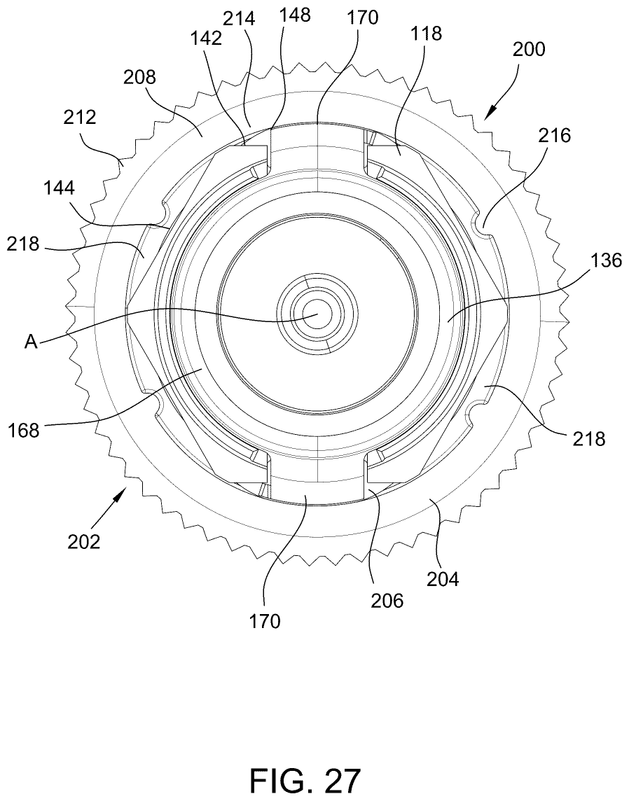

Referring to FIGS. 27-30, the sleeve 202 is sized to extend around the nut 118 and around the lock member 136 coupled to the nut 118 when the nut is positioned within the bore 206. For example, the bore 206 of the sleeve 202 has an inner diameter that is the same as or slightly greater than a maximum width of the nut 118. When the sleeve 202 is positioned on the nut 118, the ribs 216 are configured to engage the nut 118 and limit rotation of the sleeve 202 relative to the nut 118 and maintain an alignment of the sleeve 202 relative to the nut in the locked or unlocked position.

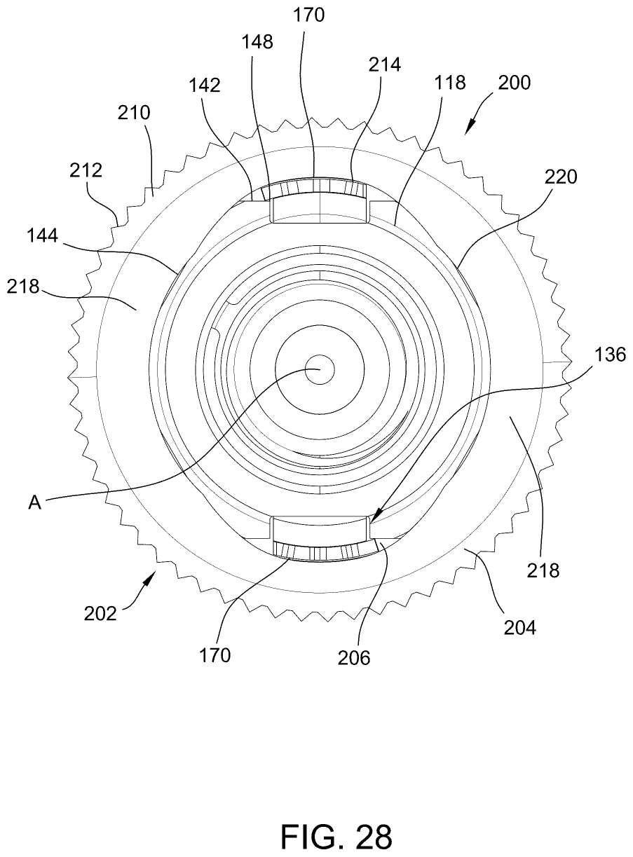

FIGS. 27 and 28 illustrate the lock assembly 102 and the sleeve 202 in the locked position. The sleeve 202 extends around and is coupled to the lock assembly 102. For example, the flanges 218 of the sleeve 202 extend between the nut 118 and the washer 138 and couple the sleeve 202 to the lock assembly 102. In the locked position, the spring fingers 170 of the lock member 136 are positioned within the wider portion of the opening of the sleeve 202. Accordingly, the sleeve 202 does not engage or displace the spring fingers 170 in the locked position. In addition, the ribs 216 are spaced from the nut 118 in the locked position.

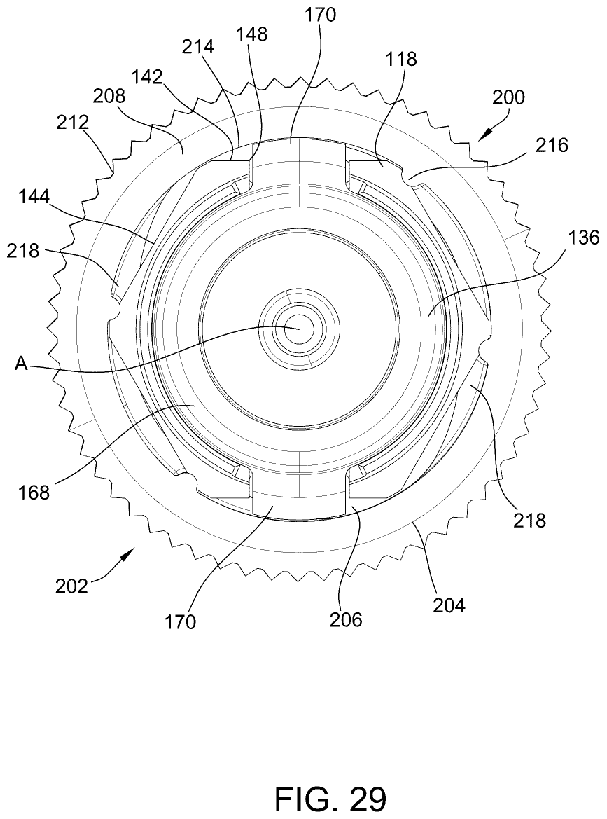

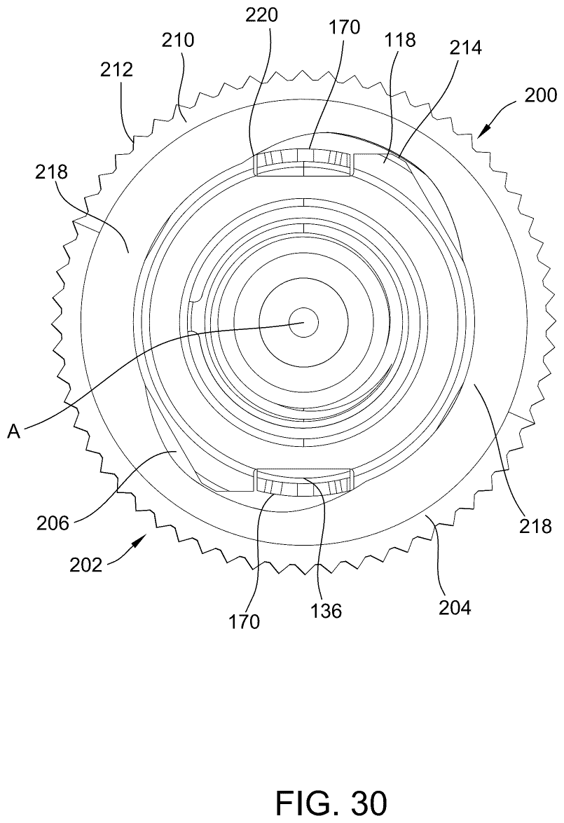

FIGS. 29 and 30 illustrated the lock assembly 102 and the sleeve 202 in the unlocked position. In the unlocked position, the flanges 218 of the sleeve 202 engage and displace the spring fingers 170 of the lock member 136. For example, in the unlocked position, the spring fingers 170 are positioned within the narrow portion of the opening at the second end 210 defined by the flanges 218. Accordingly, the flanges 218 force the spring fingers 170 radially inward and the nut 118 and the lock member 136 are able to rotate relative to the washer 138. The sleeve 202 may be rotated with the lock member 136 and the nut 118 to facilitate loosening the nut 118. For example, the ribs 216 on the sleeve 202 engage the nut 118 and facilitate the sleeve 202 rotating with the nut 118 in the unlocked position.

Referring to FIGS. 27-30, in the example, the sleeve 202 is positionable to cause the lock assembly 102 to move between the locked position and the unlocked position. For example, as illustrated in FIGS. 27-30, the sleeve 202 is rotated about the longitudinal axis A to switch the lock assembly 102 between the locked position and the unlocked position. Rotation of the sleeve 202 causes the spring fingers 170 of the lock member 136 to move within the sleeve 202 in a direction perpendicular to the longitudinal axis A and switch the lock assembly 102 between the locked position and the unlocked position.

When the sleeve 202 is moved, the flanges 218 are arranged to selectively engage the spring fingers 170 and cause the spring fingers 170 to displace. For example, the spring fingers 170 fit within the bore 206 and the wider portion of the opening at the second end 210 of the body 204 when the sleeve 202 is in the locked position. The curves edges 220 of the flanges 218 are configured to engage the spring fingers 170 and cause the spring fingers 170 to be displaced radially inward when the sleeve 202 is rotated. The spring fingers 170 are displaced gradually along the curve of the curved edge to a maximum displacement when the sleeve 202 is in an unlocked position. The ribs 216 may engage the nut 118 to stop rotation of the sleeve 202 relative to the nut 118 when the lock assembly 102 is in the unlocked position. In the unlocked position, the spring fingers 170 are displaced by the sleeve 202 to a position such that the teeth 120 are spaced from the notches.

In operation, with reference to FIGS. 27 and 28, in the locked position, the lock member 136 and the nut 118 are fixed axially and rotationally relative to the washer 138 and the threaded member 112. The sleeve 202 is rotated about the longitudinal axis A to switch the lock assembly 102 between the locked position and the unlocked position. In the unlocked position shown in FIGS. 29 and 30, the lock member 136 and the nut 118 are rotationally free relative to the washer 138 and the threaded member 112. Rotation of the nut 118 relative to the threaded member 112 displaces the nut 118 axially relative to the threaded member 112 and releases the first electrical connector 104 from the second electrical connector 106. Accordingly, the sleeve 202 facilitates simple and easy connection or disconnection of the electrical connectors 104, 106 without the use of tools.

Embodiments of the disclosure provide numerous benefits and technical advantages. For example, the electrical connection assemblies provide for simple and secure couplings of electrical elements. For example, the electrical connection assemblies may include a lock assembly that provides a positive mechanical lock. In addition, the fastener assemblies provide relatively high vibration and temperature resistance and provide secure and reliable connections in applications in which the fastener assemblies may experience excessive vibrations and high temperatures. Moreover, the locking mechanisms for the electrical connection assemblies provide a reversible and reusable solution that is simple to install and utilizes standard tooling or is usable without tools to reduce the costs of using or installing the fastener assemblies.

Examples of systems and methods for rotationally electrical connection assemblies are described above. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrical connection assembly comprising:
a first electrical element;
a threaded member coupled to the first electrical element;
a second electrical element;
a nut coupled to the second electrical element and configured to threadingly engage the threaded member, wherein the first electrical element and the second electrical element are engageable to provide an electrical connection when the nut is secured to the threaded member; and
a lock assembly that is positionable between a locked position in which the nut is fixed against rotation relative to the threaded member, and an unlocked position in which the nut is rotatable relative to the threaded member, wherein the lock assembly includes a tooth that is configured to fix rotation of the nut relative to the threaded member in the locked position and that is displaced in the unlocked position,
wherein the first electrical element is engaged with the second electrical element when the lock assembly is in the locked position.

2. The electrical connection assembly in accordance with claim 1, wherein the lock assembly comprises:
a lock member rotatable with the nut; and
a washer engageable with the lock member and fixed against rotation relative to the threaded member.

3. The electrical connection assembly in accordance with claim 2, wherein the lock member includes the tooth, and wherein the washer includes a notch configured to receive the tooth when the lock assembly is in the locked position.

4. The electrical connection assembly in accordance with claim 3, wherein the lock member comprises an annular body and an axially-extending spring finger coupled to the annular body, the axially-extending spring finger comprising a free end that that is movable in a radial direction when the lock assembly is switched between the locked position and the unlocked position, wherein the tooth extends axially from the free end.

5. The electrical connection assembly in accordance with claim 1, wherein the lock assembly includes a finger that extends along a longitudinal axis of the electrical connection assembly, wherein the tooth is disposed on the finger, and wherein the finger and the tooth on the finger are moved in a direction not parallel to the longitudinal axis to switch the lock assembly between the locked position and the unlocked position.

6. The electrical connection assembly in accordance with claim 5, further comprising a sleeve positionable around the lock assembly and configured to selectively engage the finger of the lock assembly to move the finger, wherein the sleeve is rotated about the longitudinal axis to cause the lock assembly to switch between the locked position and the unlocked position.

7. The electrical connection assembly in accordance with claim 1, wherein the lock assembly includes an axially-extending finger, wherein the nut comprises an outer surface having an axially-extending slot defined therein, wherein the nut is arranged to receive the axially-extending finger at least partly within the axially-extending slot.

8. The electrical connection assembly in accordance with claim 1, wherein, in the unlocked position, the tooth is displaced radially inward.

9. The electrical connection assembly in accordance with claim 1, wherein the tooth is releasably coupled to the nut or the threaded member.

10. An electrical connection assembly comprising:
a first electrical element;
a second electrical element, wherein the first electrical element and the second electrical element are engageable to provide an electrical connection;
a lock assembly that is positionable between a locked position and an unlocked position, wherein the lock assembly includes:
a lock member;
a washer engageable with the lock member and fixed against rotation relative to one of the first electrical element or the second electrical element; and
a tooth connected to the lock member or the washer, wherein the tooth is configured to fix rotation of the lock member relative to the washer when the lock assembly is in the locked position, and allow rotation of the lock member relative to the washer when the lock assembly is in the unlocked position, and wherein the tooth is moved to switch the lock assembly between the locked position and the unlocked position,
wherein the first electrical element is engaged with the second electrical element when the lock assembly is in the locked position, and
wherein the first electrical element and the second electrical element are fixed against rotation relative to each other by the lock member and the washer when the lock assembly is in the locked position.

11. The electrical connection assembly in accordance with claim 10, wherein the lock member includes a spring finger extending along a longitudinal axis of the electrical connection assembly, wherein the tooth is disposed on the spring finger, and wherein the spring finger is movable in a direction not parallel to the longitudinal axis to switch the lock assembly between the locked position and the unlocked position.

12. The electrical connection assembly in accordance with claim 11, wherein the washer includes a notch configured to receive the tooth when the lock assembly is in the locked position.

13. The electrical connection assembly in accordance with claim 11, further comprising a sleeve positionable around the lock assembly and configured to selectively engage the finger of the lock assembly to move the finger, wherein the sleeve is rotated about the longitudinal axis to cause the lock assembly to switch between the locked position and the unlocked position.

14. The electrical connection assembly in accordance with claim 11, wherein, in the unlocked position, the tooth is displaced radially inward.

15. The electrical connection assembly in accordance with claim 11, wherein the tooth is releasably coupled to the first electrical element or the second electrical element.

16. An electrical connection assembly comprising:
a first electrical element;
a second electrical element, wherein the first electrical element and the second electrical element are engageable to provide an electrical connection, and wherein the first electrical element and the second electrical element extend along a longitudinal axis;
a lock assembly that is positionable between a locked position, and an unlocked position, wherein the lock assembly includes a tooth that is configured to secure the lock assembly in the locked position; and
a sleeve positionable around the lock assembly, wherein the sleeve is rotated about the longitudinal axis to displace the tooth and cause the lock assembly to switch between the locked position and the unlocked position,
wherein the first electrical element is engaged with the second electrical element when the lock assembly is in the locked position.

17. The electrical connection assembly in accordance with claim 16, wherein the lock assembly includes a lock member including a spring finger extending along a longitudinal axis of the electrical connection assembly, wherein the tooth is disposed on the spring finger, and wherein the spring finger is movable in a direction not parallel to the longitudinal axis to switch the lock assembly between the locked position and the unlocked position.

18. The electrical connection assembly in accordance with claim 17, wherein the lock assembly includes a washer including a notch configured to receive the tooth when the lock assembly is in the locked position.

19. The electrical connection assembly in accordance with claim 18, further comprising:
a threaded member coupled to the first electrical element, wherein the washer is releasably coupled to the threaded member and fixed against rotation relative to the threaded member; and
a nut coupled to the second electrical element and configured to threadingly engage the threaded member, wherein the lock member is releasably coupled to the nut and fixed against rotation relative to the nut.

20. A method of assembling the electrical connection assembly of claim 1, the method comprising:
coupling the threaded member to the first electrical element;
coupling the nut to the second electrical element; and
coupling the lock assembly to at least one of the nut or the threaded member, wherein the lock assembly is positionable between the locked position in which the nut is fixed against rotation relative to the threaded member, and the unlocked position in which the nut is rotatable relative to the threaded member, wherein the lock assembly includes the tooth that is configured to fix rotation of the nut relative to the threaded member in the locked position and that is displaced in the unlocked position,
wherein the first electrical connection component is engaged with the second electrical connection component when the lock assembly is in the locked position.
